(19) United States
(12) Patent Application Publication
(10) Pub. No.: US 2015/0019594 A1
(43) Pub. Date: Jan. 15, 2015

(54) WELDING SYSTEM DATA MANAGEMENT SYSTEM AND METHOD

(71) Applicant: ILLINOIS TOOL WORKS INC., Glenview, IL (US)

(72) Inventors: Nathan John Lamers, Appleton, WI (US); Caleb Robert Krisher, Appleton, WI (US); Michael Anthony Gill, Neenah, WI (US)

(21) Appl. No.: 14/316,250

(22) Filed: Jun. 26, 2014

Related U.S. Application Data
(60) Provisional application No. 61/842,850, filed on Jul. 3, 2013.

(51) Int. Cl. G06F 17/30

(52) U.S. Cl. CPC G06F 17/30345; G06F 17/30312; G06F 17/30572
USPC 707/805

(57) ABSTRACT

A metal fabrication resource performance data management method, includes storing a first set of data representative of a first plurality of parameters sampled during a metal fabrication operation of a first metal fabrication resource, selecting a second metal fabrication resource from the listing, and changing a first identifier of a portion of the first set of data to a second identifier associated with the second metal fabrication resource. The first metal fabrication resource is selectable by a user from a listing of individual and groups of resources, and the first set of data includes the first identifier corresponding to the first metal fabrication resource. A second set of data includes the second identifier corresponding to the second metal fabrication resource.

### CROSS-REFERENCE TO RELATED APPLICATION

This application claims priority from and the benefit of U.S. Provisional Application Ser. No. 61/842,850, entitled “WELDING SYSTEM DATA MANAGEMENT SYSTEM AND METHOD,” filed Jul. 3, 2013, which is hereby incorporated by reference in its entirety for all purposes.

### BACKGROUND

The invention relates generally to metal fabrication including heating systems, cutting systems, welding systems and support equipment for heating, cutting, and welding operations. In particular, the invention relates to techniques for managing data associated with such systems.

A wide range of welding systems have been developed, along with ancillary and support equipment for various fabrication, repair, and other applications. For example, welding systems are ubiquitous throughout industry for assembling parts, structures and sub-structures, frames, and many components. These systems may be manual, automated or semi-automated. A modern manufacturing and fabrication entity may use a large number of metal fabrication systems, and these may be grouped by location, task, job, and so forth. Smaller operations may use metal fabrication systems from time to time, but these are often nevertheless critical to their operations. For some entities and individuals, metal fabrication systems may be stationary or mobile, such as mounted on carts, trucks, and repair vehicles. In all of these scenarios it is increasingly useful to set performance criteria, monitor performance, analyze performance, and, wherein possible, report performance to the operator and/or to management teams and engineers. Such analysis allows for planning of resources, determinations of prices and profitability, scheduling of resources, enterprise-wide accountability, among many other uses.

Systems designed to gather, store, analyze and report welding system performance have not, however, reached a point where they are easily and effectively utilized. In some entities limited tracking of welds, weld quality, and system and operator performance may be available. However, these do not typically allow for any significant degree of analysis, tracking or comparison. Improvements are needed in such tools. More specifically, improvements would be useful that allow for data to be gathered at one or multiple locations and from one or multiple systems, analysis performed, and reports generated and presented at the same or other locations. Other improvements might include the ability to manage data acquired from one or more systems as welding systems are added to the monitoring system.

### BRIEF DESCRIPTION

The present disclosure sets forth systems and methods designed to respond to such needs. In accordance with certain aspects of the disclosure, a metal fabrication resource performance data management method includes storing a first set of data representative of a first plurality of parameters sampled during a metal fabrication operation of a first metal fabrication resource, selecting a second metal fabrication resource from the listing, and changing a first identifier of a portion of the first set of data to a second identifier associated with the second metal fabrication resource. The first metal fabrication resource is selectable by a user from a listing of individual and groups of resources, and the first set of data includes the first identifier corresponding to the first metal fabrication resource. A second set of data includes the second identifier corresponding to the second metal fabrication resource.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of exemplary monitoring system for gathering information, storing information, analyzing the information, and presenting analysis results in accordance with aspects of the present disclosure, here applied to a large manufacturing and fabrication entity;

FIG. 2 is a diagrammatical view of an application of the system for a single or mobile welding system with which the techniques may be applied;

FIG. 3 is a diagrammatical representation of an exemplary cloud-based implementation of the system;

FIG. 4 is a diagrammatical view of an exemplary welding system of the type that might be monitored and analyzed in accordance with the techniques;

FIG. 5 is a diagrammatical representation of certain functional components of the monitoring and analysis system;

FIG. 6 is an exemplary web page view for reporting of a goals and performance of welding systems via the system;

FIG. 7 is another exemplary web page view illustrating an interface for setting such goals;

FIG. 8 is a further exemplary web page view of a goal setting interface;

FIG. 9 is an exemplary web page view of an interface for tracing parameters of a particular weld or system;

FIG. 10 is an exemplary web page view listing historical welds that may be analyzed and presented;

FIG. 11 is an exemplary web page view of historical traces available via the system;

FIG. 12 is an exemplary web page view of a status interface allowing for selection of systems and groups of systems for comparison;

FIG. 13 is an exemplary web page view of a comparison of systems and groups of systems selected via the interface of FIG. 12;

FIG. 14 is a diagrammatical representation of merging data records associated with a welding system;

FIG. 15 is an exemplary web page view of a configuration page for a welding system; and

FIG. 16 is a flowchart of a method for merging data records associated with a first welding system into data records associated with a second welding system.

### DETAILED DESCRIPTION

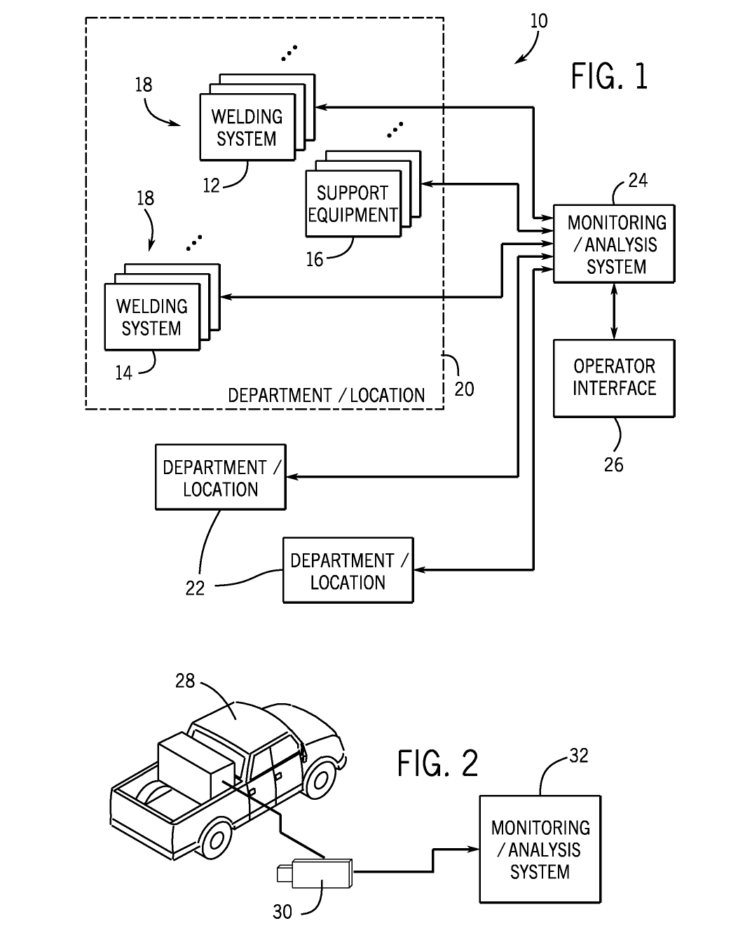

As illustrated generally in FIG. 1, a monitoring system 10 allows for monitoring and analysis of one or multiple metal fabrication systems and support equipment. In this view, multiple welding systems 12 and 14 may be interacted with, as may be support equipment 16. The welding systems and support equipment may be physically and/or analytically grouped as indicated generally by reference numeral 18. Such grouping may allow for enhanced data gathering, data analysis, comparison, and so forth. As described in greater detail below, even where groupings are not physical (i.e., the systems are not physically located near one another), highly flexible groupings may be formed at any time through use of the present techniques. In the illustrated embodiment, the equipment is further grouped in a department or location as indicated by reference numeral 20. Other departments and locations may be similarly associated as indicated by reference numeral 22. As will be appreciated by those skilled in the art, in sophisticated manufacturing and fabrication entities, different locations, facilities, factories, plants, and so forth may be situated in various parts of the same country, or internationally. The present techniques allow for collection of system data from all such systems regardless of their location. Moreover, the groupings into such departments, locations and other equipment sets are highly flexible, regardless of the actual location of the equipment.

In general, as represented in FIG. 1, the system includes a monitoring/analysis system 24 that communicates with the monitoring welding systems and support equipment, and that can collect information from these when desired. A number of different scenarios may be envisaged for accessing and collecting the information. For example, certain welding systems and support equipment will be provided with sensors, control circuitry, feedback circuits, and so forth that allow for collection of welding parameter data. Some details of such systems are described below. Where system parameters such as arc on time are analyzed, for example, data may be collected in each system reflecting when welding arcs are established and times during which welding arcs are maintained. Currents and voltages will commonly be sensed and data representative of these will be stored. For support equipment, such as grinders, lights, positioners, fixtures, and so forth, different parameters may be monitored, such as currents, switch closures, and so forth.

As noted, many systems will be capable of collecting such data and storing the data within the system itself. In other scenarios, local networks, computer systems, servers, shared memory, and so forth will be provided that can centralize at least at some extent the data collected. Such networks and support components are not illustrated in FIG. 1 for clarity. The monitoring/analysis system 24, then, may collect this information directly from the systems or from any support component that themselves collect and store the data. The data will typically be tagged with such identifying information as system designations, system types, time and date, part and weld specification, where applicable, operator and/or shift identifications, and so forth. Many such parameters may be monitored on a regular basis and maintained in the system. The monitoring/analysis system 24 may itself store such information, or may make use of extraneous memory.

As described more fully below, the system allows for grouping of the information, analysis of the information, and presentation of the information via one or more operator interfaces 26. In many cases the operator interface may comprise a conventional computer workstation, a handheld device, a tablet computer, or any other suitable interface. It is presently contemplated that a number of different device platforms may be accommodated, and web pages containing useful interfaces, analysis, reports, and the like will be presented in a general purpose interface, such as a browser. It is contemplated that, although different device platforms may use different data transmission and display standards, the system is generally platform-agnostic, allowing reports and summaries of monitored and analyzed data to be requested and presented on any of a variety of devices, such as desktop workstations, laptop computers, tablet computers, hand-held devices and telephones, and so forth. The system may include verification and authentication features, such as by prompting for user names, passwords, and so forth.

The system may be designed for a wide range of welding system types, scenarios, applications, and numbers. While FIG. 1 illustrates a scenario that might occur in a large manufacturing or fabrication facility or entity, the system may equally well applied to much smaller applications, and even to individual welders. As shown in FIG. 2, for example, even welders that operate independently and in mobile settings may be accommodated. The application illustrated of FIG. 2 is an engine-driven generator/welder 28 provided in a truck or work vehicle. In these scenarios, it is contemplated that data may be collected by one of several mechanisms. The welder itself may be capable of transmitting the data wirelessly via its own communications circuitry, or may communicate data via a device connected to the welding system, such as communications circuits within the vehicle, a smart phone, a tablet or laptop computers, and so forth. The system could also be tethered to a data collection point when it arrives at a specified location. In the illustration of FIG. 2 a removable memory device 30, such as a flash drive may be provided that can collect the information from the system and move the information into a monitoring/analysis system 32. In smaller applications of this type, the system may be particularly designed for reduced data sets, and analysis that would be more useful to the welding operators and entities involved. It should be apparent to those skilled in the art, then, that the system can be scaled and adapted to any one of a wide range of use cases.

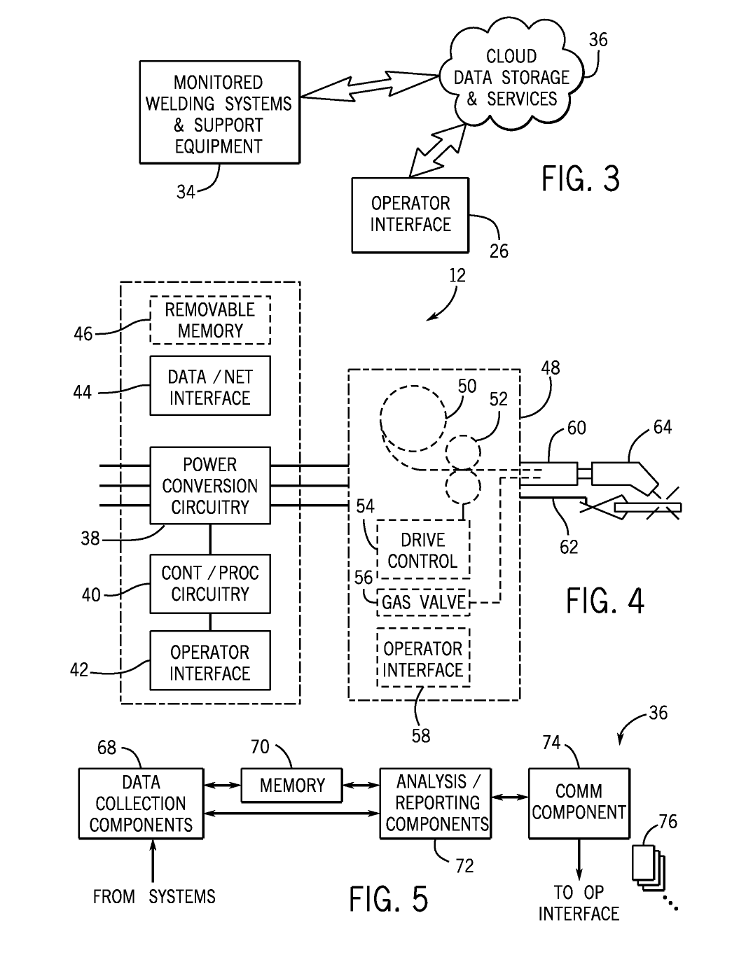

FIG. 3 illustrates an exemplary implementation, for example, which is cloud-based. This implementation is presently contemplated for many scenarios in which data collection, storage, and analysis are performed remotely, such as on a subscription or paid service basis. Here the monitored welding system and support equipment 34 communicate directly and indirectly with one or more cloud data storage and services entities 36. The entities may take any desired form, and significant enhancements in such services are occurring and will continue to occur in coming years. It is contemplated, for example, that a third party provider may contract with a fabricating or manufacturing entity to collect information from the systems, store the information off-site, and perform processing on the information that allows for the analysis and reporting described below. The operator interfaces 26 may be similar to those discussed above, but would typically be addressed to (“hit”) a website for the cloud-based service. Following authentication, then, web pages may be served that allow for the desired monitoring, analysis and presentation. The cloud-based services would therefore include components such as communications devices, memory devices, servers, data processing and analysis hardware and software, and so forth.

As noted above, many different types and configurations of welding systems may be accommodated by the present techniques. Those skilled in the welding arts will readily appreciate that certain such systems have become standards throughout industry. These include, for example, systems commonly referred to as gas metal arc welding (GMAW), gas tungsten gas arc welding (GTAW), shielded metal arc welding (SMAW), submerged arc welding (SAW), laser, and stud welding systems to mention only a few. All such systems rely on application of energy to workpieces and electrodes to at least partially melt and fuse metals. The systems may be used with or without filler metal, but most systems common in industry do use some form of filler metal which is either machine or hand fed. Moreover, certain systems may be used with other materials than metals, and these systems, too, are intended to be serviced where appropriate by the present techniques.

By way of example only, FIG. 4 illustrates an exemplary welding system 12, in this case a MIG welding system. The system includes a power supply that receives incoming power, such as from a generator or the power grid and converts the incoming power to weld power. Power conversion circuitry 38 allows for such conversion, and will typically include power electronic devices that are controlled to provide altering current (AC), direct current, pulsed or other waveforms as defined by welding processes and procedures. The power conversion circuitry will typically be controlled by control and processing circuitry 40. Such circuitry will be supported by memory (not separately shown) that stores welding process definitions, operator-set parameters, and so forth. In a typical system, such parameters may be set via an operator interface 42. The systems will include some type of data or network interface as indicated at reference numeral 44. In many such systems this circuitry will be included in the power supply, although it could be located in a separate device. The system allows for performing welding operations, collecting both control and actual data (e.g., feedback of voltages, currents, wire feed speeds, etc.). Where desired, certain of this data may be stored in a removable memory 46. In many systems, however, the information will be stored in the same memory devices that support the control and processing circuitry 40.

In the case of a MIG system, a separate wire feeder 48 may be provided. The components of the wire feeder are illustrated here in dashed lines because some systems may optionally use wire feeders. The illustrated system, again, intended only to be exemplary. Such wire feeders, where utilized typically include a spool of welding wire electrode wire 50 and a drive mechanism 52 that contacts and drives the wire under the control of a drive control circuitry 54. The drive control circuitry may be set to provide a desired wire feed speed in a conventional manner. In a typical MIG system a gas valve 56 will allow for control of the flow of the shield and gas. Setting on the wire feeder may be made via an operator interface 58. The welding wire, gas, and power is provided by a weld cable as indicated diagrammatically at reference numeral 60, and a return cable (sometimes referred to as a ground cable) 62. The return cable is commonly coupled to a workpiece via a clamp and the power, wire, and gas supplied via the weld cable to a welding torch 64.

Here again, it should be noted that the system of FIG. 4 is exemplary only, the present techniques allow for monitoring and analysis of performance of these types of cutting, heating, and welding systems, as well as others. Indeed, the same monitoring analysis system may collect data from different types, makes, sizes, and versions of metal fabrication systems. The data collected and analyzed may relate to different processes and weld procedures on the same or different systems. Moreover, as discussed above, data may be collected from support equipment used in, around or with the metal fabrication systems.

FIG. 5 illustrates certain functional components that may typically be found in the monitoring/analysis system. In the notation used in FIG. 5, these components will be located in a cloud-based service entity, although similar components may be included in any one of the implementations of the system. The components may include, for example, data collection components 68 that receive data from systems and entities. The data collection components may “pull” the data by prompting data exchange with the systems, or may work on a “push” basis where data is provided to the data collection components by the systems without prompting (e.g., at the initiation of the welding system, network device, or management system to which the equipment is connected). The data collection may occur at any desired frequency, or at points in time that are not cyclic. For example, data may be collected on an occasional basis as welding operations are performed, or data may be provided periodically, such as on a shift basis, a daily basis, a weekly basis, or simple as desired by a welding operator or facilities management team. The systems will also include memory 70 that store raw and/or processed data collected from the systems. Analysis/reporting components 72 allow for processing of the raw data, and associating the resulting analysis with systems, entities, groups, welding operators, and so forth. Examples of the analysis and reporting component operations are provided in greater detail below. Finally, communications components 74 allow for populating reports and interface pages with the results of the analysis. A wide range of such pages may be provided as indicated by reference numeral 76 in FIG. 5, some of which are described in detail below. The communications components 74 may thus include various servers, modems, Internet interfaces, web page definitions, and the like.

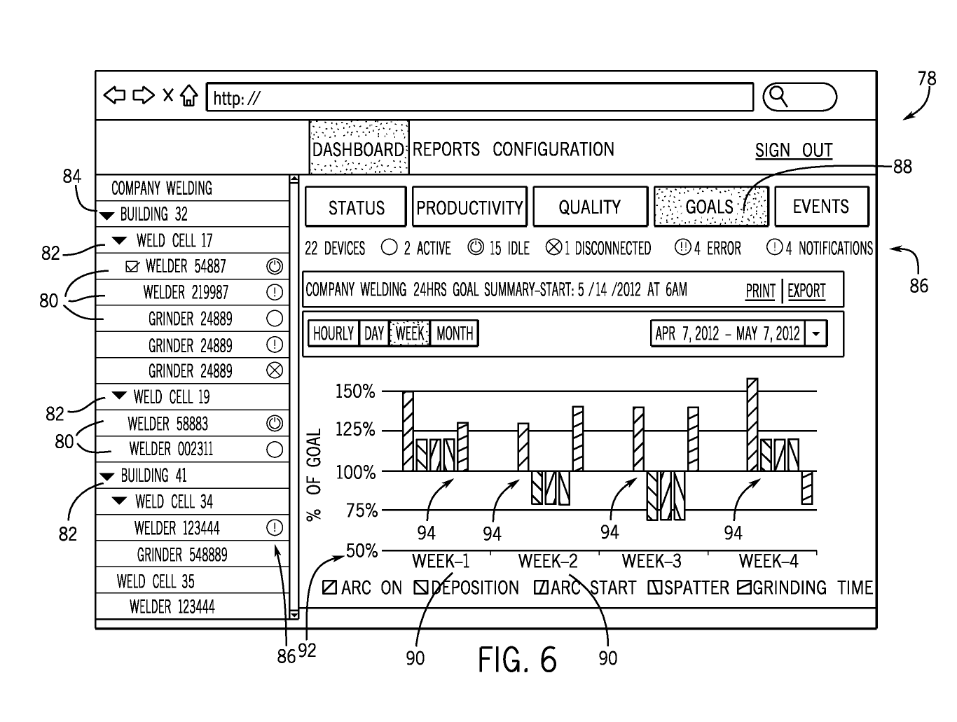

As noted above, the present techniques allow for a wide range of data to be collected from welding systems and support equipment for setup, configuration, storage, analysis, tracking, monitoring, comparison and so forth. In the presently contemplated embodiments this information is summarized in a series of interface pages that may be configured as web pages that can be provided to and viewed on a general purpose browser. In practice, however, any suitable interface may be used. The use of general purpose browsers and similar interfaces, however, allows for the data to be served to any range of device platforms and different types of devices, including stationary workstations, enterprise systems, but also mobile and handheld devices as mentioned above. FIGS. 6-13 illustrate exemplary interface pages that may be provided for a range of uses.

Referring first to FIG. 6, a goal report page 78 is illustrated. This page allows for the display of one or more welding system and support equipment designations as well as performance analysis based upon goals set for the systems. In the page illustrated in FIG. 6, a number of welding systems and support equipment are identified as indicated at reference numeral 80. These may be associated in groups as indicated by reference numeral 82. In practice, the data underlying all of the analyses discussed in the present disclosure are associated with individual systems. These may be freely associated with one another, then, by the interface tools. In the illustrated example, a location or department 84 has been created with several groups designated within the location. Each of these groups, then, may include one or more welding systems and any other equipment as shown in the figure. The present embodiment allows for free association of these systems so that useful analysis of individual systems, groups of systems, locations, and so forth may be performed. The systems and support equipment may be in a single physical proximity, but this need not be the case. Groups may be created for example, based on system type, work schedules, production and products, and so forth. In systems where operators provide personal identification information, this information may be tracked in addition to or instead of system information.

In the illustrated embodiment status indicators are illustrated for conveying the current operational status of the monitored systems and equipment. These indicators, as designated by reference numeral 86, may indicate, for example, active systems, idle systems, disconnected systems, errors, notifications, and so forth. Where system status can be monitored on a real-time or near real-time basis, such indicators may provide useful feedback to management personnel on the current status of the equipment. The particular information illustrated in FIG. 6 is obtained, in the present implementation, by selecting (e.g., clicking on) a goals tab 88. The information presented may be associated in useful time slots or durations, such as successive weeks of use as indicated by reference numeral 90. Any suitable time period may utilized, such as hourly, daily, weekly, monthly, shift-based designations, and so forth.

The page 78 also presents the results of analysis of each of a range of performance criteria based upon goals set for the system or systems selected. In the illustrated example a welding system has been selected as indicated by the check mark in the equipment tree on the left, and performance on the basis of several criteria is presented in bar chart form. In this example, a number of monitored criteria are indicated, such as arc on time, deposition, arc starts, spatter, and grinding time. A goal has been set for the particular system as discussed below, and the performance of the system as compared to this goal is indicated by the bars for each monitored parameter. It should be noted that certain of the parameters may be positive in convention while others may be negative. That is, by way of example, for arc on times, representing the portion of the working time in which a welding arc is established and maintained, a percentage of goal exceeding the set standard may be beneficial or desirable. For other parameters, such as spatter, exceeding a goal may actually be detrimental to work quality. As discussed below, the present implementation allows for designation of whether the analysis and presentation may consider these conventionally positive or conventionally negative. The resulting presentations 94 allow for readily visualizing the actual performance as compared to the pre-established goals.

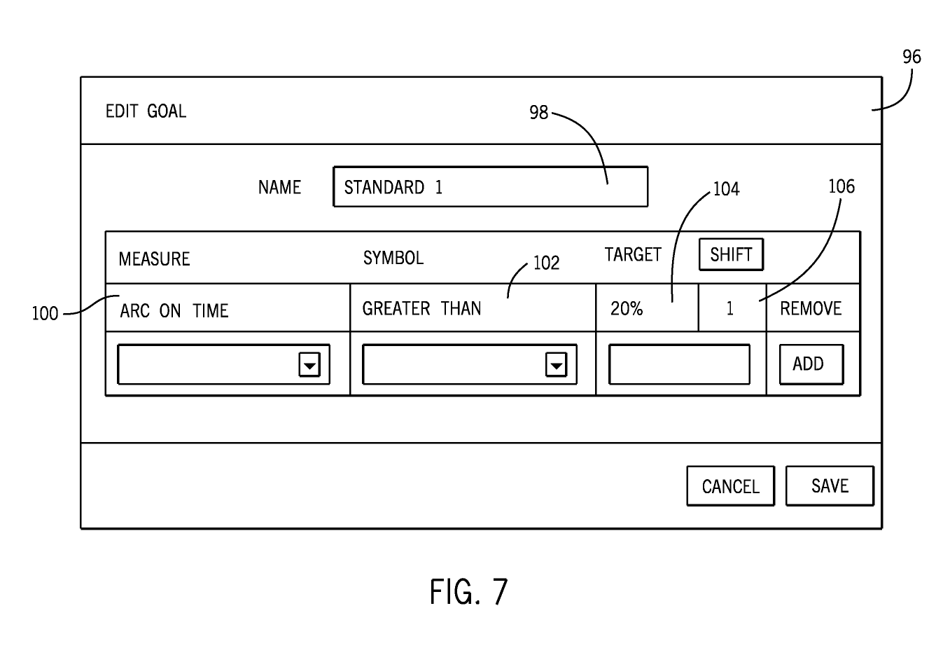

FIG. 7 illustrates an exemplary goal editing page 96. Certain fields may be provided that allow for setting of standard or commonly used goals, or specific goals for specific purposes. For example, a name of the goal may be designated in a field 98. The other information pertaining to this name may be stored for use in analyzing the same or different systems. As indicated by reference numeral 100, the illustrated page allows for setting a standard for the goal, such as arc on time. Other standards and parameters may be specified so long as data may be collected that either directly or indirectly indicates the desired standard (i.e., allows for establishment of a value for comparison and presentation). A convention for the goal may be set as indicated at reference numeral 102. That is, as discussed above, certain goals it may be desired or beneficial that the established goal define a maximum value targeted, while other goals may establish a minimum value targeted. A target 104 may then be established, such as on a numerical percentage basis, an objective (e.g., unit) basis, relative basis, or any other useful basis. Further fields, such as a shift field 106 may be provided. Still further, in some implementations it may be useful to begin goal or standard setting with an exemplary weld known to have been done and possess characteristics that are acceptable. Goals may then be set with this as a standard, or with one or more parameters set based on this weld (e.g., +/−20%).

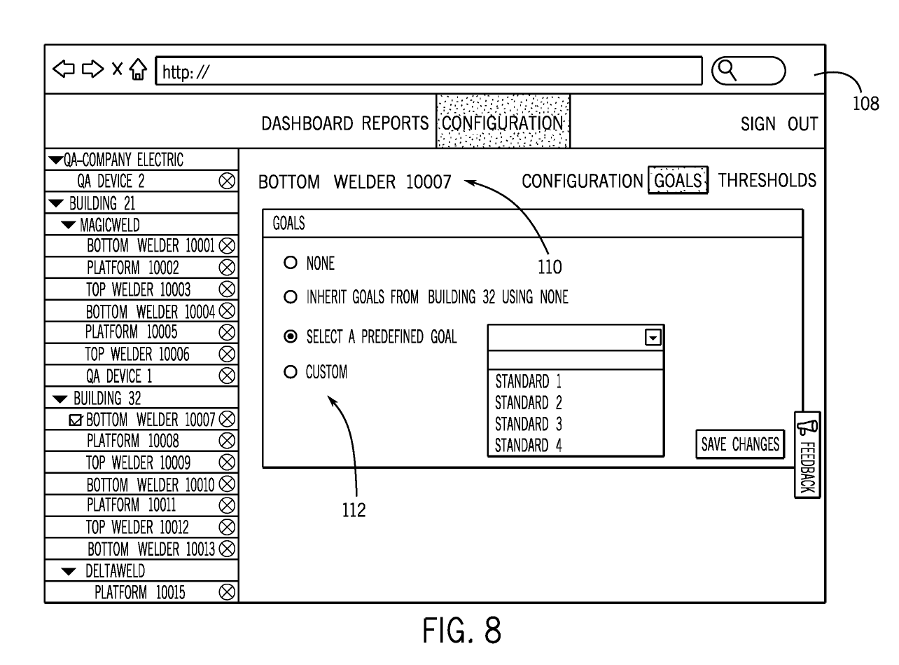

FIG. 8 illustrates a goal setting page 108 that may take established goals set by pages such as that illustrated in FIG. 7 and apply them to specific equipment. In the page 108 of FIG. 8, a welding system designated “bottom welder” has been selected as indicated by the check mark to the left. The system identification 110 appears in the page. A menu of goals or standards is then displayed as indicated by reference numeral 112. In this example, selections include placing no goal on the equipment, inheriting certain goals set for a particular location (or other logical grouping), selecting a pre-defined goal (such as a goal established by a page such as thus shown in FIG. 7), and establishing a custom goal for the equipment.

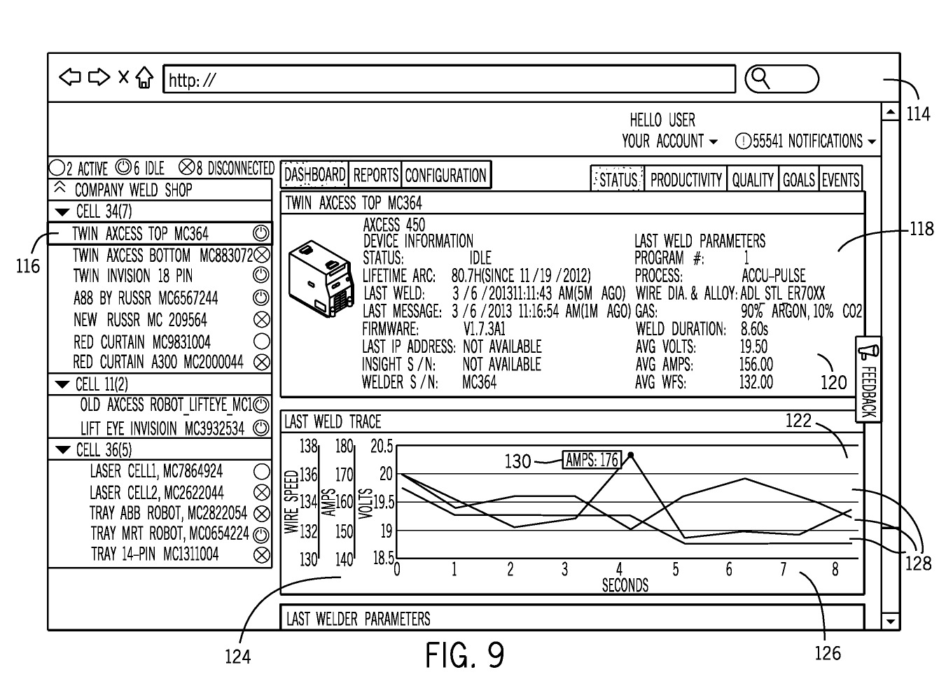

The present techniques also allow for storing and analyzing certain performance parameters of systems in tracking or trace views. These views can be extremely informative in terms of specific welds, performance over certain periods of time, performance by particular operators, performance on particular jobs or parts, and so forth. An exemplary weld trace page 114 is illustrated in FIG. 9. As indicated on this page, a range of equipment may be selected as indicated on the left of the page, with one particular system being currently selected as indicated by reference numeral 116. Once selected, in this implementation a range of data relating to this particular system is displayed as indicated by reference numeral 118. This information may be drawn from the system or from archived data for the system, such as within an organization, within a cloud resource, and so forth. Certain statistical data may be aggregated and displayed as indicated at reference numeral 120.

The weld trace page also includes a graphical presentation of traces of certain monitor parameters that may be of particular interest. The weld trace section 122, in this example, shows several parameters 124 graphed as a function of time along a horizontal access 126. In this particular example, the parameters include wire feed speed, current, and volts. The weld for which the cases are illustrated in the example had duration of approximately 8 seconds. During this time the monitored parameters changed, and data reflective of these parameters was sampled and stored. The individual traces 128 for each parameter are then generated and presented to the user. Further, in this example by a “mouse over” or other input the system may display the particular value for one or more parameters at a specific point in time as indicated by reference numeral 130.

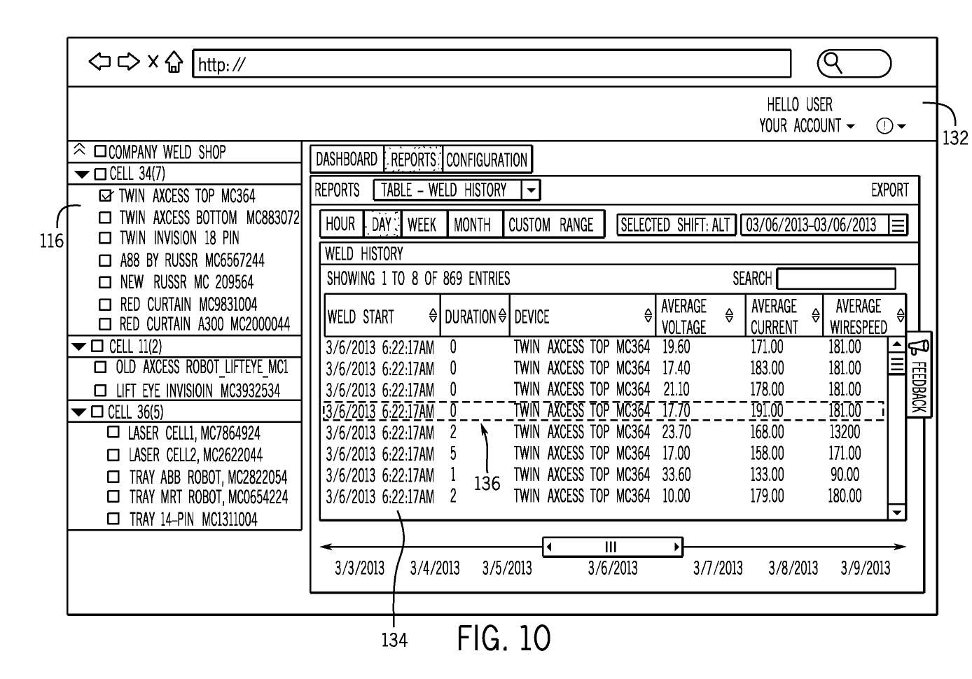

The trace pages may be populated, as may any of the pages discussed in the present disclosure, in advance or upon demand by a user. This being the case, the trace pages for any number of systems, and specific welds may be stored for later analysis and presentation. A history page 132 may thus be compiled, such as illustrated in FIG. 10. In the history page illustrated, a list of welds performed on a selected system 116 (or combination of selected systems) is presented as indicated by reference numeral 134. These welds may be identified by times, system, duration, weld parameters, and so forth. Moreover, such lists may be compiled for specific operators, specific products and articles of manufacture, and so forth. In the illustrated embodiment, a particular weld has been selected by the user as indicated at reference numeral 136.

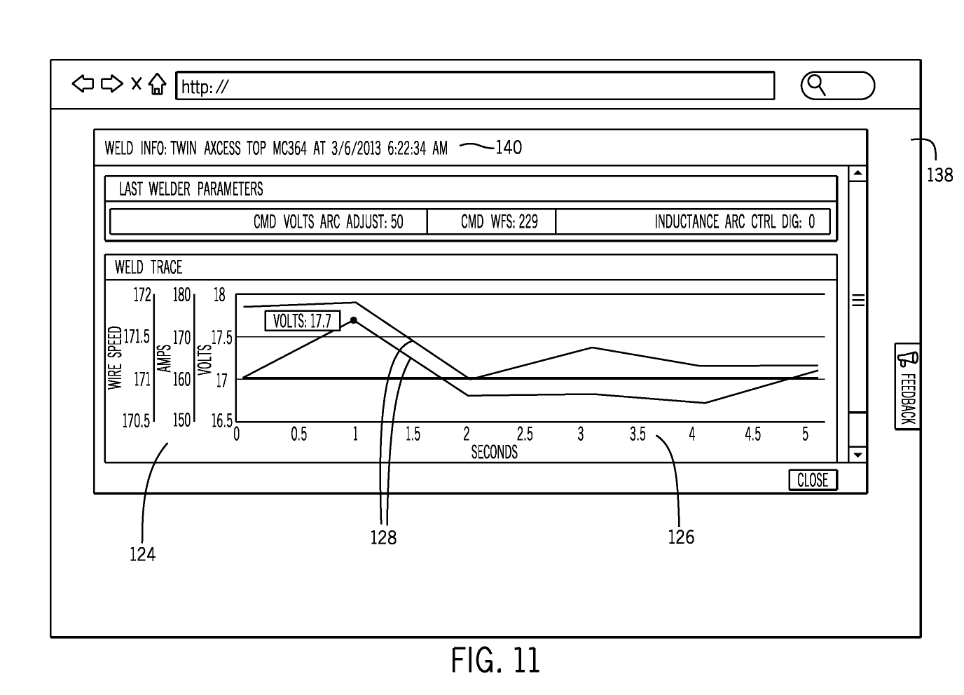

FIG. 11 illustrates an historical trace page 138 that may be displayed following selection of the particular weld 136. In this view, an identification of the system, along with the time and date, are provided as indicated by reference numeral 140. Here again, monitored parameters are identified as indicated by reference numeral 124, and a time axis 126 is provided along which traces 128 are displayed. As will be appreciated by those skilled in the art, the ability to store and compile such analyses may be significantly useful in evaluating system performance, operator performance, performance on particular parts, performance of departments and facilities, and so forth.

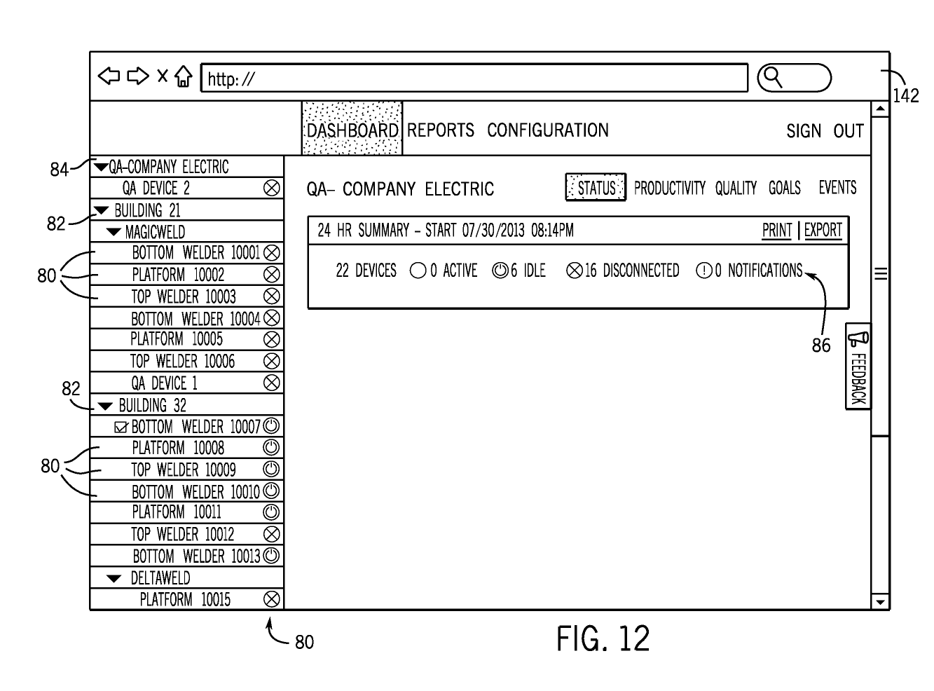

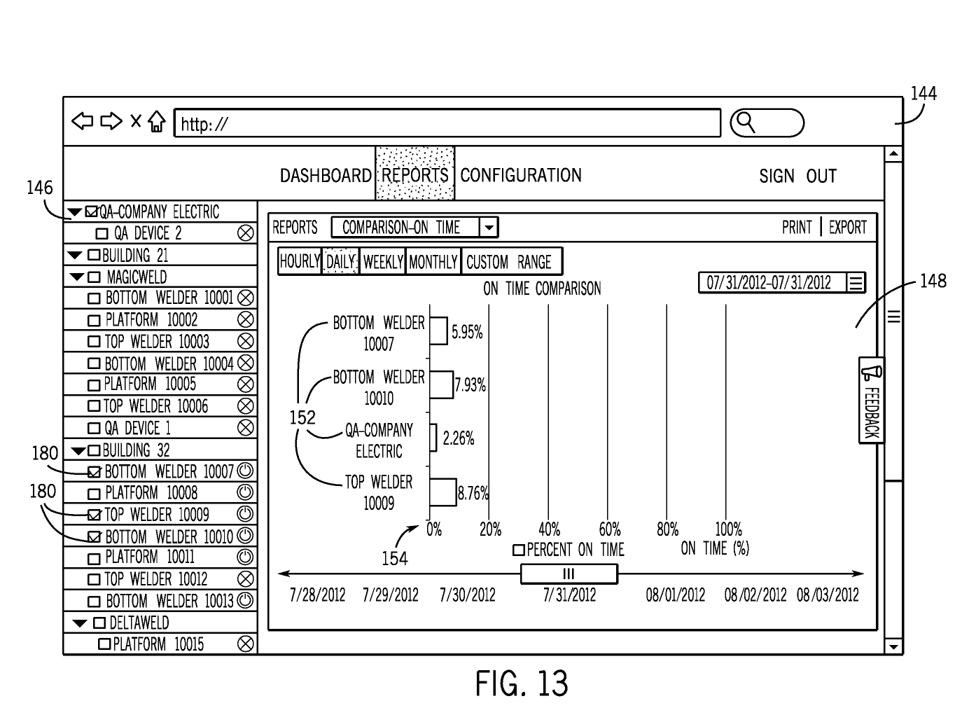

Still further, the present techniques allow for comparisons between equipment on a wide range of bases. Indeed, systems may be compared, and presentations resulting from the comparison may be provided any suitable parameter that may form the basis for such comparisons. An exemplary comparison selection page 142 is illustrated in FIG. 12. As shown in this page, multiple systems 80 are again grouped into groups 82 for a facilities or locations 84. Status indicators 86 may be provided for the individual systems or groups. The status page illustrated in FIG. 12 may then serve as the basis for selecting systems for comparison as illustrated in FIG. 13. Here, the same systems and groups are available for selection and comparison. The comparison page 144 displays these systems and allows users to click or select individual systems, groups, or any sub-group that is created at will. That is, while an entire group of systems may be selected, the user may select individual systems or individual groups as indicated by reference numeral 146. A comparison section 148 is provided in which a time base for a comparison may be selected, such as on an hourly, daily, weekly, monthly, or any other range. Once selected, then, desired parameters are compared for the individual systems, with the systems being identified as indicated at reference numeral 152, and the comparisons being made and in this case graphically displayed as indicated by reference numeral 154. In the illustrated example, for example, system on time has been selected as a basis for the comparison. Data for each individual system reflective of the respective on time of the system has been analyzed and presented in a percentage basis by a horizontal bar. Other comparisons may be made directly between the systems, such as to indicate that one system has outperformed another on the basis of the selected parameter. More than one parameter could be selected in certain embodiments, and these may be based on raw, processed or calculated values.

The monitoring/analysis system 24 acquires data (e.g., current, voltage, wire feed speed, system run time, arc on time, etc.) from the welding systems 12 and support equipment 16, and the monitoring/analysis system 24 generates data records associated with the welding systems 12 and support equipment 16 based at least in part on the acquired data. As discussed above with respect to FIG. 10, a history page 132 may present a weld history list 134 of welds performed by the selected system 116 (or combination of selected systems). The weld history list 134 is an example of data records that may include information such as the arc starts, arc duration, weld parameters, and so forth of the selected system 116. In some embodiments, data records may include a log of events associated with the selected system 116, including, but not limited to, installation or removal of components (e.g., wire spool, torch contact tip, gas supply), updates to circuitry components, and changes to operating settings (e.g., current, voltage, wire feed speed). The weld history, event log, and other data associated with each system (e.g., welding system 12, support equipment 16) may be stored as data records in a memory of the respective system, a memory of the monitoring/analysis system 24, and/or a cloud resource.

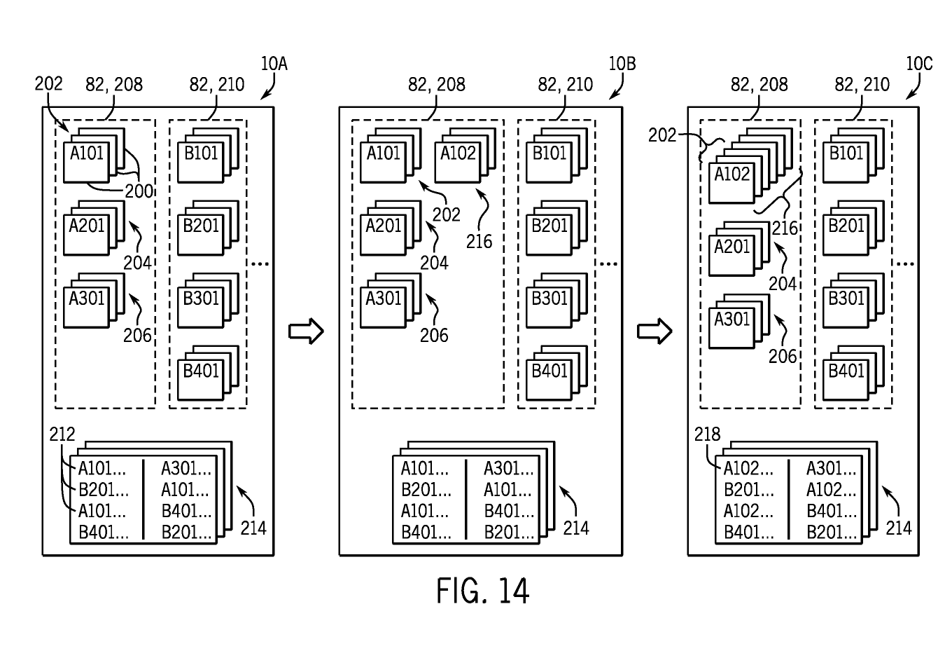

FIG. 14 is a diagrammatical representation of a monitoring system 10A with multiple data records 200 for groups 82 of systems (e.g., welding systems 12, support equipment 16). The data records 200 may be managed to accommodate the addition and removal of groups 82 and/or systems to the monitoring system 10A. The monitoring system 10A may include one or more groups 208, 210, and each group may include one or more systems. The monitoring system 10A may utilize an identifier (e.g., serial number, identification number, file name) for each system to organize and sort data records 200 in the memory and/or cloud resource. FIG. 14 illustrates each set of data records 200 with identifiers A101, A201, A301 for respective systems in the first group 208, and identifiers B101, B201, B301, B401 for respective systems in the second group 210. For example, a first set 202 of data records 200 are associated by identifier A101 with a first system, a second set 204 of data records 200 are associated by identifier A201 with a second system, and a third set 206 of data records 200 are associated by identifier A301 with a third system. As may be appreciated, each of the systems of the second group 210 is associated with a respective set of data records 200 with identifiers B101, B201, B301, and B401. The data records 200 associated with each system may be stored on memory within the respective systems and/or a cloud resource. In some embodiments, one or more items 212 refer to the identifiers of respective systems, and the items 212 may be stored as secondary data records 214. Secondary data records 214 may include, but are not limited to, user generated reports, system configuration settings, system backup data, and listings of welding systems 12 and/or support equipment 16 in each group 82.

As may be appreciated, the monitoring systems 10A, 10B, and 10C are the same monitoring system at different points in time. The monitoring system 10A illustrates the sets of data records 200 and secondary data records 214 prior to adding a replacement system and prior to merging data records 200 from a replaced system into the data records for a replacement system. The monitoring system 10B illustrates the sets of data records 200 and secondary data records 214 after installation of the replacement system and before merging of the respective data records 200. The monitoring system 10C illustrates the sets of data records 200 and secondary data records 214 after merging of data records 200.

The monitoring system 10A acquires and processes the first set 202 of data records 200 associated with a welding system identified as A101 in addition to data records 200 associated with other systems and identifiers. As may be appreciated, the system identified as A101 may be a welding system 12 (e.g., stick, TIG, MIG system), cutting system, or support equipment 16 (e.g., grinder, light, positioner, fixture, etc.). The first set 202 of data records 200 and the items 212 with identifier A101 form a first history of the welding system A101 that is stored in the monitoring system 10A (e.g., in a memory and/or the cloud resource). Data records 200 are added to the first history during operation of the welding system A101. In some embodiments, the welding system A101 is utilized at a designated worksite and/or performs a designated set of duties, and the other systems of the first group 208 are utilized at other worksites and perform other duties. The first history of welding system A101 relates to the designated worksite and/or the designated set of duties performed by welding system A101.

At some time (e.g., during a maintenance session), another welding system identified as A102 may be added to the first group 208. Monitoring system 10B acquires and processes a fourth set 216 of data records 200 associated with the added welding system A102. The fourth set 216 of data records 200 and items 212 with identifier A102 form a second history of welding system A102 that is stored in the monitoring system 10B (e.g., in a memory and/or a cloud resource). In some embodiments, the system A102 is a replacement welding system for the system A101. That is, the welding system A101 may be replaced so that the welding system A102 is utilized at the designated worksite and/or performs the designated set of duties previously performed by welding system A101. Accordingly, the second history in the monitoring system 10B relates to the designated worksite and/or the designated set of duties performed by welding system A102. However, the second history in the monitoring system 10B includes only the data records after the addition of the system A102. However, the first set 202 of data records 200 associated with the welding system A101 may be relevant to the operation of the welding system A102, to an evaluation of the set of duties performed at the designated location of the welding systems A101 and A102, and/or to an evaluation of the first group 208. Moreover, items 212 with the identifier A101 may affect the accuracy and/or control of the monitoring system 10B after the welding system A101 has been replaced. In some embodiments, the first set 202 of data records 200 and the first history remain in a memory and/or the cloud resource despite the physical removal (e.g., disconnection) of the corresponding welding system A101. However, the first set 202 of data records 200 in the monitoring system 10B are associated with the identifier A101 rather than the identifier A102 of the replacement welding system.

Presently contemplated embodiments of the monitoring system 10 enable a user to merge (e.g., copy) data records 200 associated with a first identifier (e.g., A101) into a set of data records 200 associated with a second identifier (e.g., A102). The monitoring system 10C illustrates the fourth set 216 of data records 200 associated with identifier A102 in which the fourth set 216 of data records 200 includes at least a portion of the first set 202 of data records 200 previously associated with identifier A101. The first set 202 of data records 200 associated with the welding system A101 may be modified to be associated within the monitoring system 10C with the replacement welding system A102. In some embodiments, the identifier (e.g., serial number, identification number, file name) for the first set 202 of data records 200 may be changed from being associated with the welding system A101 to being associated with the replacement welding system A102. In some embodiments, items 218 with identifiers in secondary data records 214 may be modified to recite the identifier A102 associated with the replacement welding system rather than the identifier A101 associated with the replaced welding system. Thus, the second history of the replacement welding system A102 may include the first history associated with welding system A101, the fourth set 216 of data records 200, and the secondary data records 214 acquired and/or processed in association with welding system A102. In some embodiments, the first set 202 of data records 200 with the identifier A101 may be deleted from the memory and/or the cloud resource after the first set 202 of data records 200 is merged into the fourth set 216 of data records 200.

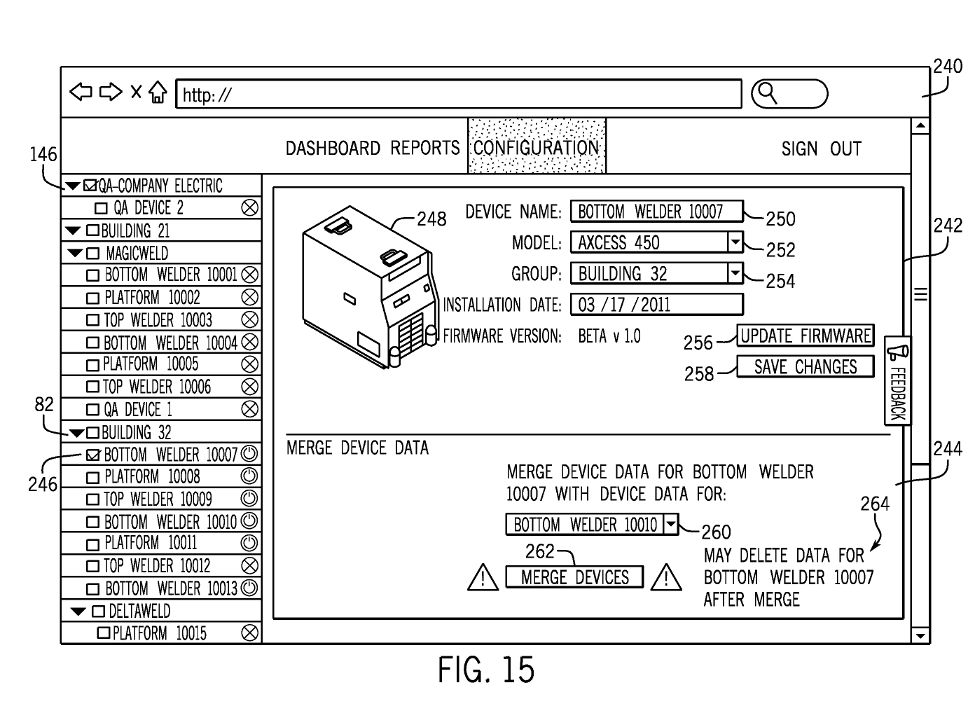

FIG. 15 is an embodiment of a web page view of a configuration page 240 of the monitoring system 10. The user may input system information in a configuration section 242, and may merge device data with another system in a merge section 244. The user may select a system 246 (e.g., welding system 12, support equipment 16) from a list of systems and groups 82 coupled to the monitoring system 10. The configuration section 242 enables the user to modify properties of the selected system 246, including, but not limited to, the device name 250, the model 252 of the system 246, and a group association 254 for the selected system 246. The user may select the model 252 from a list of model systems compatible with the monitoring system 10. The user may select the group association 254 for the system 246 from a list and/or create a new group association. In some embodiments, the configuration section 242 displays an image 248 of the selected system 246, an installation date of the selected system 246, and/or a firmware version of the selected system 246. The user may update the firmware of the selected system 246 via an update control 256. The user may save changes to the configuration of the selected system 246 via a save control 258.

The user may utilize the merge section 244 to merge data records associated with the selected system 246 with data records associated with another system selected via a target merge list 260. In some embodiments, the target merge list 260 may include all of the systems coupled to the monitoring system 10. In other embodiments, the target merge list 260 includes a subset of the systems coupled to the monitoring system 10. The subset of systems may include systems similar to the selected system 246 and/or systems of the same group association 254. For example, the subset of systems selectable via the target merge list 260 when the selected system 246 is a MIG welding system may only include other MIG welding systems.

Upon user selection of a target merge system via the target merge list 260, the user may utilize a merge control 262 to merge the data records from the selected system 246 (e.g., Bottom Welder 10007 of FIG. 15) into the data records for the target merge system (e.g., Bottom Welder 10010 or FIG. 15). Merging the data records into the target merge system may include copying the data records from the selected system 246 into the set of data records for the target merge system and changing the identifiers of the copied records to correspond to the identifier of the target merge system. In some embodiments, the identifiers of the data records from the selected system 246 may be changed without producing a copy of the data records from the selected system 246. In some embodiments, merging the data records includes changing identifiers of items stored as secondary data records so that the identifiers correspond to the target merge system. The data records of the selected system 246 may be deleted from the memory and/or the cloud resource.

Accordingly, the user may utilize the merge section 244 to merge substantially all of the data records from the selected system 246 to the target merge system without manual manipulation/modification of the data records, such as manually changing the identifiers of the data records associated with the selected system 246 to the identifier of the target merge system. Merging the data records via the merge control 262 may improve the accuracy of the merge process through automation, thereby facilitating the merge process without manually (e.g., via computer terminal coupled to the monitoring system) processing the identifier for each data record. In some embodiments, the merge control 262 may increase the speed of merging the data records. In some embodiments, an end user (e.g., maintenance technician) may utilize the merge control 262 to merge data records during maintenance sessions, such as when a welding system or component of a welding system is replaced. The merge control 262 may enable an end user to merge data through the operator interface rather than requesting a system administrator, who may be at a location different from the end user, to change the identifier for the desired data records.

It may be difficult to repopulate the data records associated with the selected system 246 after a merge process if the data records are deleted or all the identifiers are changed to the identifier of the target merge system. Accordingly, one or more notifications 264 may inform the user that merging data records may render the original data records inaccessible (e.g., due to deletion of data records or identifier modification of data records). In some embodiments, selection of the merge control 262 may present a notification 264. Additionally, or in the alternative, selection of the merge control 262 may present a request for user authentication prior to merging the data records and/or deleting the original data records. For example, the user may enter a password prior to activation of the merge control 262 to merge the data records of the selected system 246.

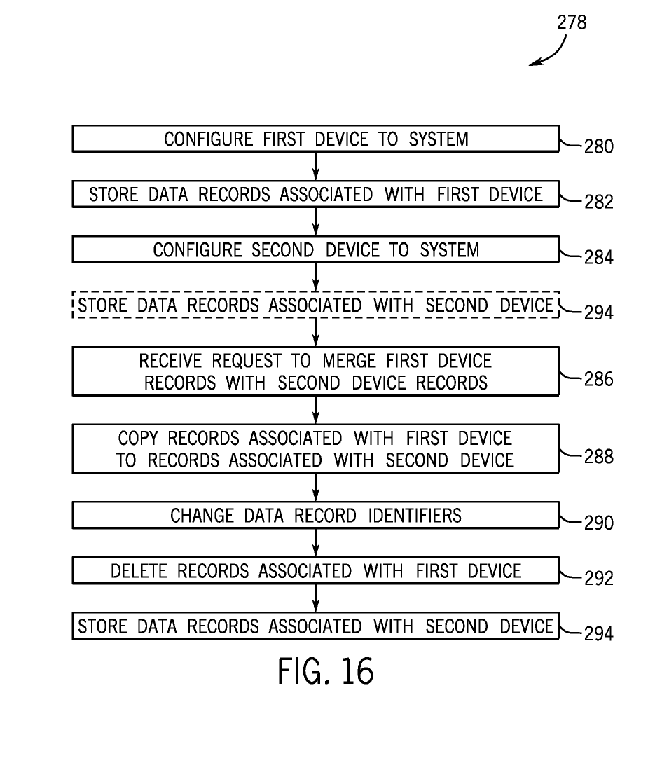

FIG. 16 illustrates an embodiment of a method 278 for merging data records associated with a first welding system into data records associated with a second welding system. The monitoring system configures (block 280) the first device (e.g., welding system, support equipment) to the monitoring system. As discussed above with FIG. 15, the user may utilize the configuration page 240 to name, categorize, and group the first device. Upon configuration of the first device, the monitoring system may store (block 282) data records associated with the first device. The data records may be stored in a memory of the device, a memory of the monitoring system, and/or a cloud resource. The stored data records may include, but are not limited to, the weld history, the event log, and other data associated with the first device.

The monitoring system configures (block 284) the second device (e.g., welding system, support equipment) to the monitoring system. In some embodiments, the second device may be configured with a similar name as the first device. In some embodiments, the second device may be associated with the same category and/or group as the first device. Upon configuration of the second device, the monitoring system may receive (block 286) a request to merge data records associated with the first device into data records associated with the second device. The user may input the request to merge data records via the configuration page 240 and merge control 262 discussed above in FIG. 15. In some embodiments, the monitoring system may copy (block 288) records associated with the first device to records associated with the second device after receiving (block 286) the request to merge data records. The monitoring system changes (block 290) the identifiers of data records from the identifier associated with the first device to the identifier associated with the second device after block 286 or 288. In embodiments in which the data records of the first device are copied, the monitoring system changes (block 290) the identifiers of the copied data records from the first device. In some embodiments in which the data records of the first device are not copied, the monitoring system changes the identifiers of the data records associated with the first device to the identifier associated with the second device upon receiving the request (block 286) to merge the data records. In some embodiments, the monitoring system changes items in the secondary data records with identifiers to the first device to items with identifiers to the second device.

The monitoring system may delete (block 292) records associated with the first device after changing (block 290) the data record identifiers. The monitoring system may store (block 294) data records associated with the second device in a memory of the second device, the monitoring system, and/or the cloud resource. As shown by the dashed block 294, the monitoring system may store data records associated with the second device after the second device is configured (block 284) to the monitoring system or after record identifiers are changed (block 290). The stored data records may include, but are not limited to, the weld history, the event log, and other data associated with the second device. As may be appreciated, the stored data records associated with the second device may be appended to the data records formerly associated with the first device prior to the merge. Accordingly, some items (e.g., data records, events) in the history of the second device may have been associated with the first device prior to the merge.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of managing data of a metal fabrication resource performance system comprising:
storing in a non-transitory computer readable media a first set of data representative of a first plurality of parameters sampled during a metal fabrication operation of a first metal fabrication resource, wherein the resource is selectable by a user from a listing of individual and groups of resources, and the first set of data comprises a first identifier corresponding to the first metal fabrication resource;
selecting a second metal fabrication resource from the listing, wherein a second set of data comprises a second identifier corresponding to the second metal fabrication resource; and
changing the first identifier of a portion of the first set of data to the second identifier.

2. The method of claim 1, comprising copying the portion of the first set of data from a first memory area corresponding to the first metal fabrication resource to a second memory area corresponding to the second metal fabrication resource.

3. The method of claim 2, comprising:
storing the second set of data representative of a second plurality of parameters sampled during a metal fabrication operation of the second metal fabrication resource; and
appending the copied portion of the first set of data to the second set of data.

4. The method of claim 3, comprising deleting the portion of the first set of data from the first memory area after appending the portion to the second set of data.

5. The method of claim 3, comprising presenting the second set of data and the appended copied portion as data corresponding to the second metal fabrication resource.

6. The method of claim 2, wherein at least one of the first memory area or the second memory area comprises a cloud based resource.

7. The method of claim 1, wherein the first set of data comprises a weld history or an event log.

8. The method of claim 1, comprising deleting references to the first identifier in the metal fabrication resource performance system after changing the first identifier of the portion of the first set of data.

9. The method of claim 1, comprising presenting a notification to an operator prior to changing the first identifier of the portion of the first set of data.

10. A metal fabrication resource performance monitoring interface comprising:
at least one user viewable configuration page defined by computer executed code transmitted to a user viewing device, the configuration page comprising:
a listing of individual and groups of metal fabrication resources;
user configurable inputs modifying properties of a selected metal fabrication resource from the listing;
a target merge list comprising a subset metal fabrication resources from the listing; and
a merge control configured to merge data records associated with the selected metal fabrication resource into data records associated with a target metal fabrication resource selected from the target merge list.

11. The interface of claim 10, wherein the code is executable by a processor for viewing in a general purpose browser.

12. The interface of claim 10, wherein the merge control is configured to delete data records associated with the selected metal fabrication resource from a memory or a cloud resource.

13. A metal fabrication resource performance monitoring system configured to:
store in a non-transitory computer readable media a first set of data representative of a first plurality of parameters sampled during a metal fabrication operation of a first metal fabrication resource, wherein the resource is selectable by a user from a listing of individual and groups of resources viewable via a viewable configuration page of a user viewing device, and the first set of data comprises a first identifier corresponding to the first metal fabrication resource;
enable selection of a second metal fabrication resource from the listing, wherein a second set of data comprises a second identifier corresponding to the second metal fabrication resource; and
change the first identifier of a portion of the first set of data to the second identifier.

14. The system of claim 13, wherein the system is configured to copy the portion of the first set of data from a first memory area corresponding to the first metal fabrication resource to a second memory area corresponding to the second metal fabrication resource.

15. The system of claim 14, wherein the system is configured to:
store the second set of data representative of a second plurality of parameters sampled during a metal fabrication operation of the second metal fabrication resource; and
append the copied portion of the first set of data to the second set of data.

16. The system of claim 15, wherein the system is configured to delete the portion of the first set of data from the first memory area after appending the portion to the second set of data.

17. The system of claim 15, wherein the system is configured to present, via the viewable configuration page, the second set of data and the appended copied portion as data corresponding to the second metal fabrication resource.

18. The system of claim 14, wherein at least one of the first memory area or the second memory area comprises a cloud based resource.

19. The system of claim 13, wherein the first set of data comprises a weld history or an event log.

20. The system of claim 13, wherein the system is configured to delete references to the first identifier after changing the first identifier of the portion of the first set of data.

21. The system of claim 13, wherein the system is configured to present, via the viewable configuration page, a notification to an operator prior to changing the first identifier of the portion of the first set of data.
